(19) United States
(12) Patent Application Publication
(10) Pub. No.: US 2022/0391784 A1
(43) Pub. Date: Dec. 8, 2022

(54) COMPUTER AUTOMATED MULTI-OBJECTIVE SCHEDULING ADVISOR

(71) Applicant: International Business Machines Corporation, Armonk, NY (US)

(72) Inventors: Soheil Seyyedi Parsa, Calgary (CA); Giovane Cesar Da Silva, Calgary (CA)

(21) Appl. No.: 17/303,718

(22) Filed: Jun. 6, 2021

(51) Int. Cl. G06Q 10/04; G06Q 10/06; G06Q 50/02; G06N 5/00; G01C 21/34

(52) U.S. Cl. CPC G06Q 10/047; G06Q 10/06398; G06Q 10/06312; G06Q 50/02; G06Q 10/063118; G06Q 10/06313; G06N 5/003; G01C 21/343; G06Q 50/26

(57) ABSTRACT

A multi-objective scheduling advisor for generating a multi-stop visitation schedule includes generating, by a computer, a road network map corresponding to a predetermined area including a plurality of tasks locations. A task to be performed is assigned to each of the plurality of task locations. The computer calculates a business value for each task location using at least one of a calculation, a selected business rule applied to a delay duration, and an input value received from a client. A duration of a respective task is calculated using historical data on task durations associated with a staff of operators over different predetermined areas to determine an average task duration for every operator in the staff. Finally, using a metaheuristic binary optimization algorithm, the computer chooses different candidate tasks for the multi-stop visitation schedule to visit multiple assets in a single trip within the predetermined area.

### BACKGROUND

The present invention generally relates to the field of computer systems for scheduling, and more particularly to generating, using a computer, a multi-objective scheduling advisor.

Multi-stop scheduling is a challenging problem for many industries. Some of these industries include, for example, oil and gas, food, shipment, farming and agriculture, e-commerce, etc. Multi-stop scheduling involves organizing and managing daily visitation tasks to be completed by a staff of operators.

In most existing commercial solutions, task scheduling is approached as a single-objective process based solely on reducing driving times. However, this approach overlooks the effect of other cost-inducing variables on task duration, staff overtime, and business revenue.

### SUMMARY

Shortcomings of the prior art are overcome and additional advantages are provided through the provision of a computer-implemented method for generating a multi-stop visitation schedule. The method includes generating, by a computer, a road network map corresponding to a predetermined area including a plurality of tasks locations for which a task to be performed is assigned to each of the plurality of task locations, calculating a business value for each task location using at least one of a calculation, a selected business rule applied to a delay duration, and an input value received from a client, calculating a duration of a respective task using historical data on task durations associated with a staff of operators over different predetermined areas to determine an average task duration for every operator in the staff, and using a metaheuristic binary optimization algorithm to choose different candidate tasks for the multi-stop visitation schedule to visit multiple assets in a single trip within the predetermined area.

Another embodiment of the present disclosure provides a computer program product for generating a multi-stop visitation schedule, based on the method described above.

Another embodiment of the present disclosure provides a computer system for generating a multi-stop visitation schedule, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2A depicts a computer system for generating a multi-objective scheduling advisor, according to an embodiment of the present disclosure;

FIG. 2B depicts an exemplary road network map, according to an embodiment of the present disclosure;

FIG. 2C is a flowchart indicating the steps of a modified binary differential evolution algorithm, according to an embodiment of the present disclosure;

FIG. 2D depicts an exemplary visualization representation of a multi-stop visitation schedule generated by the multi-objective scheduling advisor of FIG. 2A, according to an embodiment of the present disclosure;

FIG. 3 depicts a flowchart illustrating the steps of a computer-implemented method for generating a multi-stop visitation schedule using the multi-objective scheduling advisor of FIG. 2A, according to an embodiment of the present disclosure;

FIG. 4 is a block diagram of internal and external components of a computer system, according to an embodiment of the present disclosure;

FIG. 5 is a block diagram of an illustrative cloud computing environment, according to an embodiment of the present disclosure; and

FIG. 6 is a block diagram of functional layers of the illustrative cloud computing environment of FIG. 5, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously mentioned, multi-stop scheduling is a challenging problem for many industries that involves organizing and managing daily visitation tasks to be completed by a designated person (e.g., staff member, operator, etc.). Typically, the designated person has to visit multiple locations within a predetermined area during a single trip in order to complete one or more tasks at each of the multiple locations. Moreover, the one or more tasks assigned to the person need to be performed within a specified period of time (e.g., within a work shift).

The complexity of the multi-stop scheduling problem grows exponentially when environmental, staffing, logistic, and business-related constraints are taken into account. Ideally, automated task scheduling considers not only driving distance and time as main constrains, but also all profits and costs to produce a global scheduling plan that can provide maximum overall value to businesses. This type of problem represents a multi-objective combinatorial optimization problem with conflicting objectives (also known as Constrained Multi-Objective Travelling Salesman Problem).

Daily operating activities in the oil and gas industry provide a good example of the complexity of multi-objective optimization. For instance, a field operator (e.g., staff member, maintenance crew, technician, engineer, etc.) working for an oil and gas company is expected to visit several wells daily. Every morning, the field operator receives a list of wells that experienced problems over the past 12 hours and need immediate attention, such that production rates can return to normal. Additionally, the field operator may also have weekly scheduled tasks that include visits to different wells (regardless of failure or low production rates) to ensure optimal performance as well as environmental safety of the assets (e.g., due to business and government requirements). Moreover, each well may have a different production rate (i.e., different business value) as well as a different task completion time depending on the type of maintenance service required.

Currently, in the oil and gas industry, field operators plan their day based on declining production rates (e.g., from failing wells), task relevance, task duration, field location, and distance between wells. Also, field operators need to consider other constraints including working hours daily limit, vehicle availability and/or staff limitations, weather conditions, etc. Accordingly, due to the numerous tasks to be completed and the large number of variables to take into account, automatically generating a multi-stop schedule for a field operator to be completed within working hours in a way that incorporates maximum revenue generation and optimal usage of time involves a multidimensional decision making process that can be difficult to perform without the help of a computer program. Thus, there is a need for a computer automated multi-objective scheduling advisor that is capable of generating an optimized multi-stop visitation schedule including critical (business) objectives a real-time constraints.

Critical objectives to be considered in optimizing the multi-stop visitation schedule may include minimizing driving times between (visitation) locations such that the operator have enough time to deliver the service, maximizing total revenue as a result of each operator's work per day, and/or minimizing service delivery time at each location. By nature, these are conflicting objectives which may require a sophisticated optimization algorithm to find the most optimal schedule. In general, there are inherent difficulties that may make finding a solution to a multi-objective scheduling problem very challenging, some of them being:

1) Finding accurate and up-to-date road information for route optimization. Generally, this information can be obtained from (public) mapping applications such as Google maps. However, these applications may only contain information regarding public roads and ignore private roads that are built by companies to access privately-owned infrastructure. This a typical problem in the oil and gas industry since most oilfields are located within privately-owned sites.

2) Maximizing returned benefit which includes conflicting objectives, i.e., increasing profit may require driving to more locations. However, one goal of efficient multi-stop scheduling is to reduce driving time as well as to limit personnel daily activities to daily working hours. These are conflicting objectives that increase the complexity of the problem. Consequently, multi-stop scheduling becomes a non-convex optimization problem with several local minimum and one global minimum (non-unimodal objective functions). While the local solution may be enough, the main value surface with global minimum.

3) Estimating a time for completing each task. This may help calculating the total time an operator spends at a predetermined area performing assigned tasks (i.e., the summation of all task completion and driving times). Ideally, task completion time at the predetermined area may be equal or less than a duration of a work shift to avoid overtime payments. However, it would be desirable to have the flexibility of accepting and/or computing changes to task durations and apply those changes in real-time to have an updated task schedule.

The combination of the above issues creates a challenging non-convex optimization problem that may not be expandable to all industries due to data issues (e.g., not having a map of private roads). Thus, an automated visitation scheduling advisor that can address multiple related objectives and can be used, among other things, for time management, task prioritization, and productivity improvement can be fundamental for industries requiring daily multi-stops travelling routes, such as the oil and gas industry.

Therefore, embodiments of the present invention provide a method, system, and computer program product for generating a multi-stop task schedule using an automated multi-objective scheduling advisor. The following described exemplary embodiments provide a system, method, and computer program product to, among other things, obtaining an optimized task schedule based on a multi-objective scheduling advisor program that is capable of maximizing business profit by incorporating a business priority of each task as well as associated costs. The proposed embodiments provide a flexible scheduling solution that can be modified to incorporate any additional business-related objective as well as logistic and staffing constraints. Further, the proposed multi-objective scheduling advisor is capable of generating a precise map of private roads that may not be available in web mapping applications such as Google maps.

Thus, the present embodiments have the capacity to improve the technical field of computer systems by providing a multi-objective optimization solution that identifies high priority tasks over a predefined period of time (e.g., work shift) and a number of available resources for efficiently balancing task values, task durations, and driving costs in order to maximize daily profits. The proposed multi-objective optimization solution uses a metaheuristic optimization routine to find a global optimal solution (i.e., global optimum). Also, the multi-objective optimization solution provides placeholders for additional business specific constraints and objectives so they can be seamlessly augmented to the solution, and generates a graph network of private roads for precise route optimization.

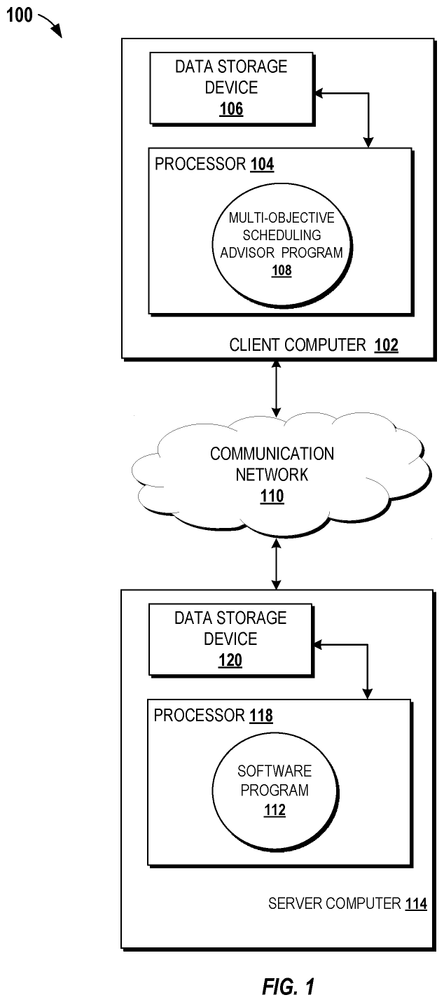

Referring now to FIG. 1, an exemplary networked computer environment 100 is depicted, according to an embodiment of the present disclosure. FIG. 1 provides only an illustration of one embodiment and does not imply any limitations with regard to the environments in which different embodiments may be implemented. Many modifications to the depicted environment may be made by those skilled in the art without departing from the scope of the invention, as recited by the claims.

The networked computer environment 100 may include a client computer 102 and a communication network 110. The client computer 102 may include a processor 104, that is enabled to run a multi-objective scheduling advisor program 108, and a data storage device 106. Client computer 102 may be, for example, a mobile device, a telephone (including smartphones), a personal digital assistant, a netbook, a laptop computer, a tablet computer, a desktop computer, or any type of computing devices capable of accessing a network.

The networked computer environment 100 may also include a server computer 114 with a processor 118, that is enabled to run a software program 112, and a data storage device 120. In some embodiments, server computer 114 may be a resource management server, a web server, an IoT device/sensor, or any other electronic device capable of receiving and sending data via the communication network 110. In another embodiment, server computer 114 may represent a server computing system utilizing multiple computers as a server system, such as in a cloud computing environment.

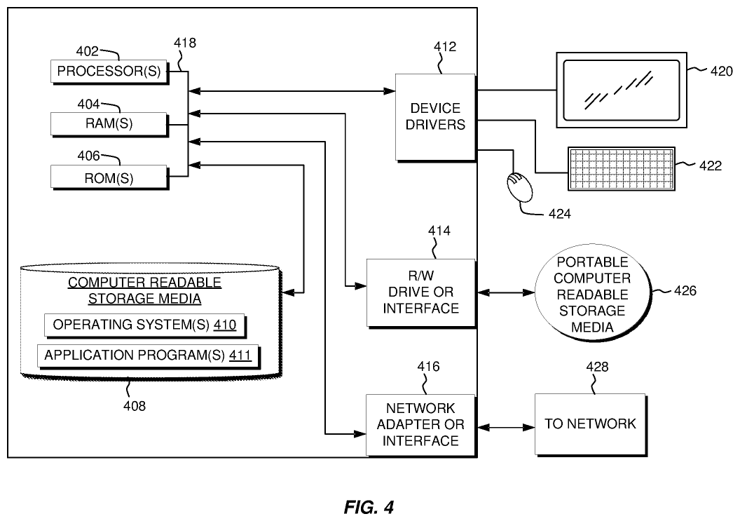

The multi-objective scheduling advisor program 108 running on client computer 102 may communicate with the software program 112 running on server computer 114 via the communication network 110. As will be discussed with reference to FIG. 4, client computer 102 and server computer 114 may include internal components and external components.

The networked computer environment 100 may include a plurality of client computers 102 and server computers 114, only one of which is shown. The communication network 110 may include various types of communication networks, such as a local area network (LAN), a wide area network (WAN), such as the Internet, the public switched telephone network (PSTN), a cellular or mobile data network (e.g., wireless Internet provided by a third or fourth generation of mobile phone mobile communication), a private branch exchange (PBX), any combination thereof, or any combination of connections and protocols that will support communications between client computer 102 and server computer 114, in accordance with embodiments of the present disclosure. The communication network 110 may include wired, wireless or fiber optic connections. As known by those skilled in the art, the networked computer environment 100 may include additional computing devices, servers or other devices not shown.

Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the present invention. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present invention.

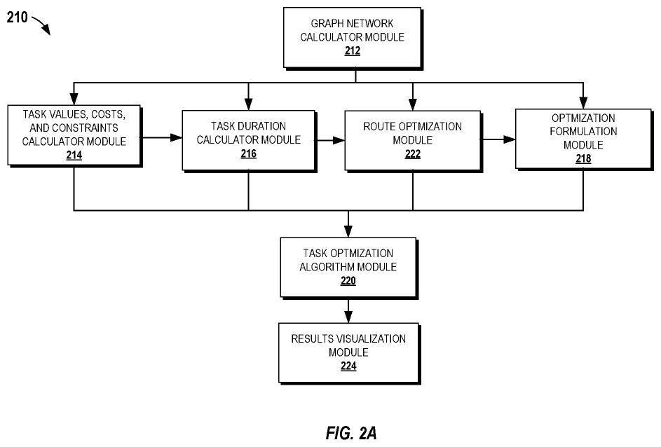

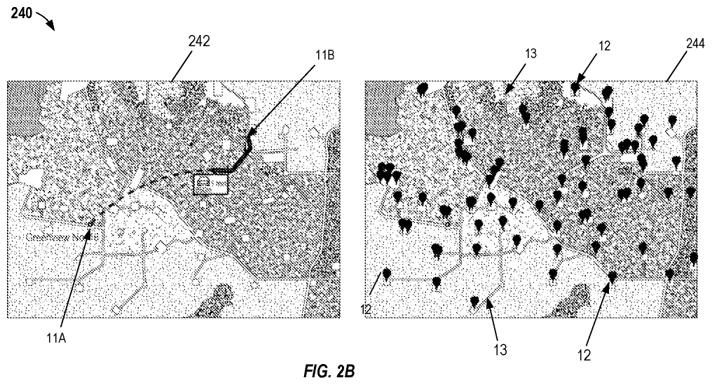

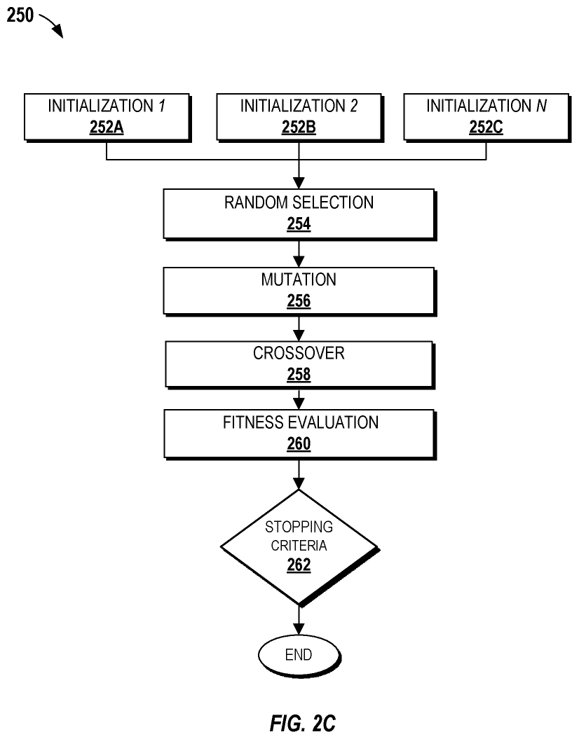

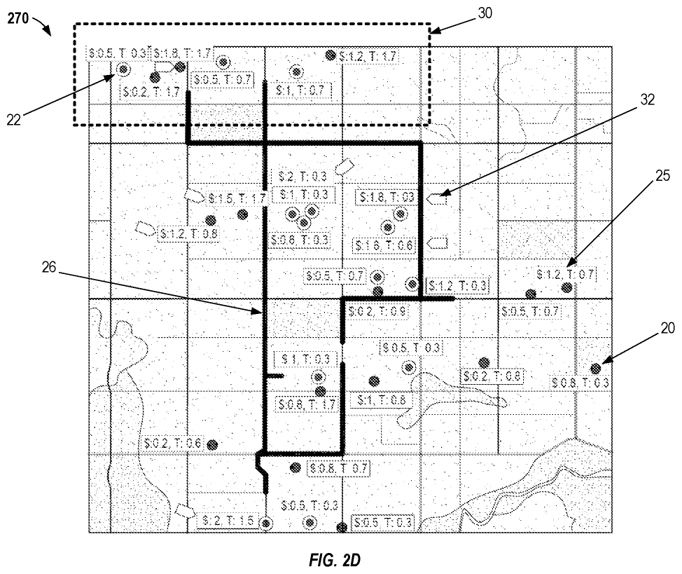

Referring now to FIG. 2A, components of a computer system 210 for generating a multi-objective scheduling advisor are shown, according to an embodiment of the present disclosure. In this embodiment, components of the computer system 210 includes a graph network calculator module 212, a task values, costs and constraints calculator module 214, a task duration calculator module 216, an optimization formulation module 218, a task optimization algorithm module 220, a route optimization module 222, and a results visualization module 224.

According to an embodiment, the graph network calculator module 212 identifies whether all roads within a (predetermined) operating area are public roads, and whether road maps are available on mapping applications such as Google maps. If one or more roads within the operating area are private roads and/or one or more road maps are not available, the graph network calculator module 212 retrieves data from a geographic information system (GIS). The retrieved GIS data is associated to private roads than can be used by the computer system 210 to generate a corresponding route map. GIS data can be obtained from, for example, clients, federal and/or regional agencies (e.g., Department of Transportation).

As known by those skilled in the art, GIS is a framework for gathering, managing, analyzing, and integrating many types of data. GIS analyzes spatial location and organizes layers of information into visualizations using maps and 3D scenes. Using GIS data, geographic coordinates (i.e., latitude, longitude, and elevation) of starting and end points of a determined (private) road can be determined by dividing the road into short segments. In some embodiments, available GPS data can also be used by the graph network calculator module 212 to generate a map of private roads. Such GPS data can be obtained from clients (e.g., from GPS data captured by transportation vehicles).

After obtaining the GIS data, the graph network calculator module 212 computes a distance between a starting point and an end point of each segment of the (private) road. Information corresponding to all segments (starting points, end points, and distances) is then used by the graph network calculator module 212 to generate a visual representation of how roads are connected and a distance between different points.

FIG. 2B depicts an example of a visual representation (map) 240 corresponding to an operating area including private roads. In this example, the operating area is an oilfield including several wells. In section 242 (left) of FIG. 2B, a mapping application such as Google maps is used to find a driving path between different well locations. As can be appreciated, the mapping application (section 242) cannot provide an accurate driving path between well location 11A and well location 11B. Section 244 (right) of FIG. 2B is a visualization of a road network generated by the graph network calculator module 212 (FIG. 2A) for the same field using collected GIS data. In this exemplary embodiment, the graph network calculator module 212 generates the road network shown in section 244 of FIG. 2B.

The visual representation of section 244 indicates a location of each well 12 within the specified operating area (i.e., field) and an indication of all private roads 13. Based on the generated visual representation of section 244, the computer system 210 can calculate a distance between any two arbitrary points (i.e., wells 12) within the operating area. Accordingly, by using GIS data, the computer system 210 is capable of generating its own route map for determining a distance between points of interest, thereby the computer system 210 becomes independent from client's data and unsatisfactory mapping applications. This capability of the computer system 210 may eliminate geographical limitations of the proposed multi-objective scheduling advisor.

With continued reference to FIG. 2A, the task values, costs, and constraints calculator module 214 of the computer system 210 computes a business value associated with each task to be performed by the operator. As may be understood, the business value of a task depends on the nature of the business or industry. For example, for an oil and gas company, the business value of a visit to a failing well may be equivalent to the well production rate under normal operating conditions times the daily price of oil. Thus, in an optimization objective function, wells with higher production rates are assigned a higher business value (i.e., a higher priority in the visitation schedule), since maximizing profit is one of the main objectives. Accordingly, the computer system 210 assigns a dollar value to each well visit. This allows providing a real-time measure of total daily profits to clients.

It should be noted that the task values, costs, and constraints calculator module 214 can incorporate any urgent or delayed task by increasing its corresponding business-value. Specifically, the task values, costs, and constraints calculator module 214 module assigns a higher scheduling priority to urgent and/or delayed tasks. In some embodiments, the scheme of delayed visitation values can be chosen with respect to business rules (i.e., linearly, exponentially, or any other monotonic increase function). For example, for businesses with strict task completion deadlines, the task values, costs, and constraints calculator module 214 can use an exponential increase function for taking into account delayed task values. So, the optimization objective algorithm treats delayed task values first.

Alternatively or additionally, the task values, costs, and constraints calculator 214 module can receive task values input directly from clients.

With continued reference to FIG. 2A, the task duration calculator module 216 collects and processes historical data corresponding to a duration interval of different tasks performed by each operator or staff member over different operating areas. Stated differently, the task duration calculator module 216 collects data associated with a time an operator or staff member spent performing a specific task within the operating area. The task duration calculator module 216 can keep track of type of tasks performed (i.e., problem solved), the staff member assigned to each task, and a time within which the staff member finished the task. For example, the task duration calculator module 216 may collect data corresponding to a time spent by a production engineer fixing a decreased production rate associated with a determined well.

The collected historical data associated with the duration of different tasks may help estimating an average time for completing a task for each staff member or operator (i.e., individual average task completion time). By doing this, the computer system 210 can plan and assign daily tasks without exceeding an allowed number of working hours per day, thereby allowing efficiently organizing personnel work shifts. This in turn may help preventing overtime payments.

Since the time spent completing a task (i.e., task duration) can be affected by severe weather conditions and location characteristics, the task duration calculator module 216 can also incorporate weather conditions and location characteristics in the calculation of task duration time. Back to the oil and gas industry example, location characteristics may include a task being performed on mature fields in which wells are generally older. In this case older infrastructure may pose different challenges to the personnel involved in completing the task. In some cases, for example, a task may need to be completed manually which may take longer time. Additionally, performing these tasks under challenging weather conditions (e.g., during a snowstorm or subfreezing temperatures) may further complicate task completion and increase service delivery time.

The above information can be collected by the task duration calculator module 216 to improve predictive capabilities of the computer system 210. According to an embodiment, a statistical based prediction method is used to estimate task duration including task type, weather conditions, and location characteristics. In situations in which historical data is not available, a few weeks of data collection can be enough for the computer system 210 to use as a starting point. With enough data collected, a robust or stochastic algorithm can be applied for increasing the reliability and value of the results. Also, machine learning techniques can be applied to forecast the task duration distribution given current environmental or technical conditions.

It should be noted that any user data collection is done with user or client consent via, for example, an opt-in and opt-out feature. As known by those skilled in the art, an opt-in and opt-out feature generally relates to methods by which the user can modify a participating status (i.e., accept or reject the data collection). In some embodiments, the opt-in and opt-out feature can include a software application(s) available in the client computer 102 (FIG. 1). Additionally, the user can choose to stop having his/her information being collected or used. In some embodiments, the user can be notified each time data is being collected. The collected data is envisioned to be secured and not shared with anyone without user's consent. The user can stop the data collection at any time.

With continued reference to FIG. 2A, the optimization formulation module 218 uses a metaheuristic binary optimization algorithm to select different candidate tasks for a multi-stop visitation schedule. For each selected task, the optimization formulation module 218 computes costs and values using a multi-objective function represented by Equation 1 below. Since driving distance is recognized as a cost, a route optimization algorithm is implemented by the route optimization module 222 to calculate an optimal driving distance including a shortest possible path between candidate visitation locations using the road map generated by the graph network calculator module 212. Then, the optimal driving time obtained in the route optimization module 222 is used by the optimization formulation module 218 to calculate driving costs, as will be explained in detail below.

$${min}_{w . r . t K} \{ α \frac{1}{( K \cdot V )} + β ( {T}_{overtime} ) \} where {T}_{overtime} = [ ShiftLimit - TotalHours ] , and TotalHours = DrivingTime ( K ) + \sum K \cdot TD \qquad Equation 1$$

Equation 1 represents an optimization formulation where K is an optimization variable including a vector of zeros and ones (ones denote tasks that are scheduled, and zeros denote tasks that are not considered). V is a vector representing the value of each task, as determined by the task values costs, and constraints calculator module 214, that assigns a dollar value to each visitation location.

The overtime portion Tₒᵥₑᵣₜᵢₘₑ of Equation 1 is a conditional function which is not activated while the summation of driving time and task duration is below ShiftLimit (i.e., total allowed hours per one working day). Otherwise, the value of overtime can be added to the objective function as a penalty. It should be noted that Equation 1 is defined as a minimization problem where the minimum of the objective function is achieved when Tₒᵥₑᵣₜᵢₘₑ equals zero and the product K.V (returned value) is maximum. α and β are tuning parameters that can increase or decrease the emphasis on each objective (i.e., weighted traveling salesman problem).

TD represents the task duration for each visit computed by the task duration calculator module 216. TD is used to calculate the total time that the operator spent at all selected locations. Additionally, DrivingTime(K) is the minimum driving time required to visit each location in the list of locations K. As explained above, the route optimization module 222 implements a second level optimization algorithm to find this value. Finally, ShiftLimit is the total hour limit for each work shift. It should be noted that ShiftLimit values can be adjusted by the client.

Accordingly, Equation 1 allows designing a schedule with a maximized returned profit while keeping the total working hours as low as possible. This is done through simultaneous analysis of task value, task duration, and corresponding driving times. In some embodiments, the multi-objective optimization function of Equation 1 can be modified to add any business-related constraint as a penalty to the objective function and update calculated driving times based on such limitations (e.g., staff, transportation, etc.). Additionally, weather data can be incorporated into Equation 1. This may help having a better estimation of driving times in case of unfavorable weather conditions. It should be noted that the objective functions of Equation 1 are non-convex and non-differentiable, this may eliminate the possibility of the scheduling problem being solved by commercial optimization software.

With continued reference to FIG. 2A, the task optimization algorithm module 220 executes a binary differential evolution (BDE) which is a metaheuristic optimization algorithm that selects a number of tasks for a work shift with a focus on maximizing a profit over a predefined time range. Since the total number of working hours is constrained, the metaheuristic optimization algorithm attempts to find a balance between task values, task durations, and driving times in order to achieve maximum profit. FIG. 2C shows the modified BDE algorithm used in embodiments of the present disclosure.

As known by those skilled in the art, metaheuristic optimization algorithms start with exploration (searching smaller sub-areas from entire objective functions) on the surface of the objective function and attempt to find a sub-area with global optimal. Then, the exploration is replaced by exploitation (more precise search on a sub-area that contain the global optimal) to narrow down the discovered sub-area and closer to the global optimal. In this embodiment, the exploration phase of the BDE algorithm has been modified by performing several simultaneous initializations 252A, 252B, and 252C.

Consequently, in this embodiment, the initial search can be highly efficient and the chance of finding a global optimum increases significantly. Also, the convergence time of the BDE algorithm is reduced since either the global optimum or a point close to it is generated during parallel initialization. This adds dynamic scheduling capabilities to the computer system 210 that can reduce solution runtime and allows implementation by operators during working hours. After multiple initializations, a random selection is performed at 254 to select a random subset of each initialization 252A, 252B, 252C to create the final initial population. Also, it is guaranteed that the members with best fitness values at 260 are passes from initialization boxes to the final initial population. It should be noted that steps 256, 258, 260, and 262 are typical of BDE algorithms, and thus will not be explained in detail.

As mentioned above, the BDE algorithm (FIG. 2C) selects several task locations for visitation. To make the selection, first all relevant objectives need to be calculated, including driving time. As previously explained, the route optimization module 222 uses a separate metaheuristic combinatorial optimization algorithm to compute the shortest driving path between candidate visiting points. Subsequently, the route optimization module 222 reports the calculated driving time to the task optimization algorithm 220 (i.e., BDE algorithm). Here, the task optimization algorithm module 220 applies an Ant Colony Optimization (ACO), which is a nature-inspired metaheuristic optimization method. As may be known by those skilled in the art, ACO provides higher performance in relatively vast graph networks.

The modified BDE algorithm of FIG. 2C allows adopting different starting points for each operator. As a result, the computer system 210 can dynamically generate an updated schedule based on a current location of each operator or staff member including task locations surrounding the current location, thereby improving task performance and reducing driving times.

With continued reference to FIG. 2A, the results visualization module 224 generates a map including a visual representation of a multi-stop task schedule. FIG. 2D shows an exemplary output of the results visualization module 224. Specifically, a map 270 is generated including all tasks to be completed within a predetermined operating area. In the exemplary embodiment of FIG. 2D, all available visitation locations 20, 22 are indicated with a black filled circle (i.e., available tasks), with visitation locations 22 being those selected by the computer system 210 (indicated with a fisheye symbol, i.e., a circle around the black filled circle). Next to each task location 20,22, a (rectangular) label 25 indicates an estimated task value (reference number next to dollar “$” sign) and a task duration T (on the right) of each circle. The task value ($) an task duration (T) displayed on each label 25 provides a visual representation that can be used to find an optimal schedule for a work shift with the objective of maximizing a profit by the end of the shift while avoiding working overtime.

Calculated optimal driving paths 26 are also indicated in FIG. 2D by a thick line. As can be observed in FIG. 2D, the computer system 210 balances task values, task durations, and driving times to maximize the returned profit. For example, there are six available task locations 20, 22 in region 30 (upper right side) of the map 270. Here, the computer system 210 determines that visiting three of the task locations 22 in region 30 can take approximately 1.7 hours with a total returned benefit of $2 (this is a unitless number). It should be noted that, this is the maximum achievable benefit over 1.7 hours, and no other task combination can reach the $2 benefit over 1.7 hours. FIG. 2D further includes an scenario in which only task locations 20, 22 with the highest $ values are selected until the 8 hours limit is met. The selected task location are indicated by tags 32. In this scenario, the total returned value is $12.1, while the total returned value using the schedule suggested by the computer system 210 (task locations 22 within optimal driving paths 26) is $15.

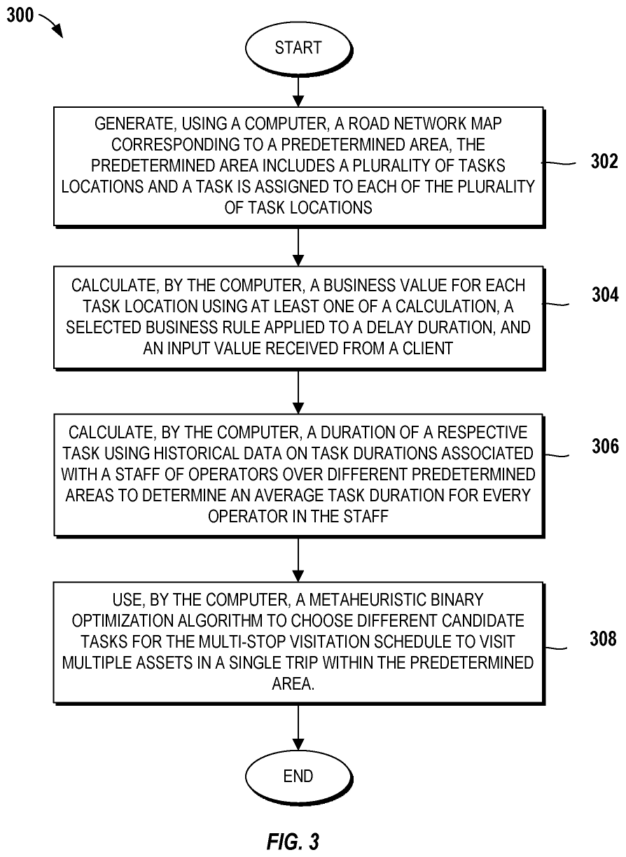

Referring now to FIG. 3, a flowchart 300 illustrating the steps of a computer-implemented method for generating a multi-stop visitation schedule using the multi-objective scheduling advisor of FIG. 2A is shown, according to an embodiment of the present disclosure.

The process starts at step 302 in which a road network map corresponding to a predetermined area is generated by the computer system 210 of FIG. 2A. The road network map is generated using information corresponding to all segments of roads in a predetermined area including a starting point, an end point, and a distance associated with each segment. The predetermined area includes a plurality of tasks locations, and one or more tasks are assigned to each of the plurality of task locations. At step 304, a business value for each task location is calculated using at least one of a calculation, a selected business rule applied to a delay duration, and an input value received from a client. The calculation can be performed using, for example, information corresponding to a well production rate multiplied by a daily price of oil.

The process continues at step 306 by calculating a duration of a respective task (i.e., a time for the task to be completed) using historical data on task durations associated with a staff of operators over different predetermined areas to determine an average task duration for every operator in the staff. At step 308 the computer system 210 (FIG. 2A) uses a metaheuristic binary optimization algorithm to choose different candidate tasks for the multi-stop visitation schedule to visit multiple assets in a single trip within the predetermined area.

According to an embodiment, using the metaheuristic binary optimization algorithm to choose different candidate tasks further includes calculating costs and values of one or more tasks using information including driving time and driving distance as costs, using a predetermined route optimization algorithm to calculate a shortest path between candidate visitation locations, identifying an optimal total path using a computed optimal total driving distance associated with the shortest path between candidate visitation locations, and calculating a driving cost associated with the optimal total path.

In some embodiments, calculated task durations and associated costs can be updated by the computer system 210 (FIG. 2A) using weather prediction data including values of precipitation, wind and temperature. Additionally, calculated task durations and associated costs can be updated using business-related constraints including vehicle limitations and staff limitations at specific areas, task urgencies, and other business-specific constraints. As explained above, this may allow real-time updates to be incorporated in the multi-stop visitation schedule.

At step 308, the computer system 210 (FIG. 2A) further generates a daily visitation schedule for each operator for all available task locations in the predetermined area indicating available tasks to be completed within a predetermined time period, an optimized driving route and road connectivity between task locations, task values, and average task completion times.

Therefore, embodiments of the present disclosure provide a method, system and computer program product to, among other things, generate an optimized multi-point visitation schedule to complete multiple tasks within a predetermined area based on a multi-objective scheduling advisor program that maximizes profits and task completion time by incorporating business priorities, associated costs, external variables such as weather conditions, and a knowledge base of task completion times for each operator in the staff. In an embodiment, the accuracy of the proposed multi-objective scheduling advisor is improved by taking into account historical data for estimating an average task duration associated with each operator. In another embodiment, the graph network of (private) roads is used as a digital map for computing driving distances while maintaining awareness of all road connectivity.

Finally, the proposed embodiments provide an optimization formulation that considers conflicting objectives and applies a modified metaheuristic optimization method for finding a global optimal solution to the multi-stop scheduling problem.

Referring now to FIG. 4, a block diagram of components of client computer 102 and server computer 114 of networked computer environment 100 of FIG. 1 is shown, according to an embodiment of the present disclosure. It should be appreciated that FIG. 4 provides only an illustration of one implementation and does not imply any limitations regarding the environments in which different embodiments may be implemented. Many modifications to the depicted environment may be made.

Client computer 102 and server computer 114 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Client computer 102 and server computer 114 may also include a R/W drive or interface 414 to read from and write to one or more portable computer readable storage media 426. Application programs 411 on client computer 102 and server computer 114 may be stored on one or more of the portable computer readable storage media 426, read via the respective R/W drive or interface 414 and loaded into the respective computer readable storage media 408.

Client computer 102 and server computer 114 may also include a network adapter or interface 416, such as a TCP/IP adapter card or wireless communication adapter (such as a 4G wireless communication adapter using OFDMA technology) for connection to a network 428. Application programs 411 on client computer 102 and server computer 114 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Client computer 102 and server computer 114 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may include hardware and software (stored on computer readable storage media 408 and/or ROM 406).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

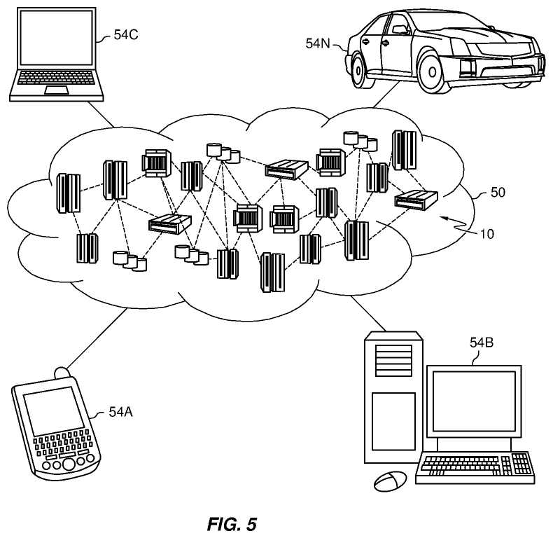

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

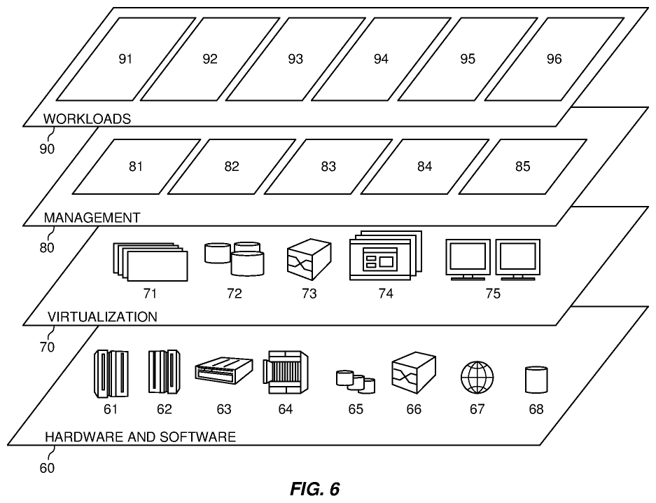

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a multi-objective scheduling advisor 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating a multi-stop visitation schedule comprising:
generating, by a computer, a road network map corresponding to a predetermined area, the predetermined area comprising a plurality of tasks locations, wherein a task is assigned to each of the plurality of task locations;
calculating, by the computer, a business value for each task location using at least one of a calculation, a selected business rule applied to a delay duration, and an input value received from a client;
calculating, by the computer, a duration of a respective task using historical data on task durations associated with a staff of operators over different predetermined areas to determine an average task duration for every operator in the staff; and
using, by the computer, a metaheuristic binary optimization algorithm to choose different candidate tasks for the multi-stop visitation schedule to visit multiple assets in a single trip within the predetermined area.

2. The computer-implemented method of claim 1, wherein the calculation is performed using information including a well production rate multiplied by a daily price of oil.

3. The computer-implemented method of claim 1, wherein using the metaheuristic binary optimization algorithm to choose the different candidate tasks further comprises:
calculating, by the computer, costs and values of one or more tasks using information including driving time and driving distance;
using, by the computer, a predetermined route optimization algorithm to calculate a shortest path between candidate visitation locations;
identifying, by the computer, an optimal total path using a computed optimal total driving distance associated with the shortest path between the candidate visitation locations; and
calculating, by the computer, a driving cost associated with the optimal total path.

4. The computer-implemented method of claim 1, further comprising:
updating, by the computer, the calculated duration and associated costs using weather prediction data including values of precipitation, wind and temperature.

5. The computer-implemented method of claim 1, further comprising:
updating, by the computer, the calculated duration and associated costs using business-related constraints including vehicle limitations and staff limitations at specific areas, task urgencies, and other business-specific constraints.

6. The computer-implemented method of claim 1, further comprising:
generating, by the computer, a daily schedule for each operator for all available task locations in the predetermined area indicating available tasks, task values and task durations to be completed within a predetermined time period.

7. The computer-implemented method of claim 1, wherein generating the road network map corresponding to the predetermined area comprises:
dividing, by the computer, each road within the predetermined area into a plurality of road segments; and
using, by the computer, information corresponding to the plurality of road segments including a starting point, an end point, and a distance associated with each road segment to generate the road network map.

8. A computer system for generating a multi-stop visitation schedule, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
generating, by a computer, a road network map corresponding to a predetermined area, the predetermined area comprising a plurality of tasks locations, wherein a task is assigned to each of the plurality of task locations;
calculating, by the computer, a business value for each task location using at least one of a calculation, a selected business rule applied to a delay duration, and an input value received from a client;
calculating, by the computer, a duration of a respective task using historical data on task durations associated with a staff of operators over different predetermined areas to determine an average task duration for every operator in the staff; and
using, by the computer, a metaheuristic binary optimization algorithm to choose different candidate tasks for the multi-stop visitation schedule to visit multiple assets in a single trip within the predetermined area.

9. The computer system of claim 8, wherein the calculation is performed using information including a well production rate multiplied by a daily price of oil.

10. The computer system of claim 8, wherein using the metaheuristic binary optimization algorithm to choose the different candidate tasks further comprises:
calculating, by the computer, costs and values of one or more tasks using information including driving time and driving distance;
using, by the computer, a predetermined route optimization algorithm to calculate a shortest path between candidate visitation locations;
identifying, by the computer, an optimal total path using a computed optimal total driving distance associated with the shortest path between the candidate visitation locations; and
calculating, by the computer, a driving cost associated with the optimal total path.

11. The computer system of claim 8, further comprising:
updating, by the computer, the calculated duration and associated costs using weather prediction data including values of precipitation, wind and temperature.

12. The computer system of claim 8, further comprising:
updating, by the computer, the calculated duration and associated costs using business-related constraints including vehicle limitations and staff limitations at specific areas, task urgencies, and other business-specific constraints.

13. The computer system of claim 8, further comprising:
generating, by the computer, a daily schedule for each operator for all available task locations in the predetermined area indicating available tasks, task values and task durations to be completed within a predetermined time period.

14. The computer system of claim 8, wherein generating the road network map corresponding to the predetermined area comprises:
dividing, by the computer, each road within the predetermined area into a plurality of road segments; and
using, by the computer, information corresponding to the plurality of road segments including a starting point, an end point, and a distance associated with each road segment to generate the road network map.

15. A computer program product for generating a multi-stop visitation schedule, comprising:
one or more computer readable storage media, and program instructions collectively stored on the one or more computer readable storage media, the program instructions comprising:
program instructions to generate, by a computer, a road network map corresponding to a predetermined area, the predetermined area comprising a plurality of tasks locations, wherein a task is assigned to each of the plurality of task locations;
program instructions to calculate, by the computer, a business value for each task location using at least one of a calculation, a selected business rule applied to a delay duration, and an input value received from a client;
program instructions to calculate, by the computer, a duration of a respective task using historical data on task durations associated with a staff of operators over different predetermined areas to determine an average task duration for every operator in the staff; and
program instructions to use, by the computer, a metaheuristic binary optimization algorithm to choose different candidate tasks for the multi-stop visitation schedule to visit multiple assets in a single trip within the predetermined area.

16. The computer program product of claim 15, wherein the calculation is performed using information including a well production rate multiplied by a daily price of oil.

17. The computer program product of claim 15, wherein the program instructions to use the metaheuristic binary optimization algorithm to choose the different candidate tasks further comprises:
program instructions to calculate, by the computer, costs and values of one or more tasks using information including driving time and driving distance;
program instructions to use, by the computer, a predetermined route optimization algorithm to calculate a shortest path between candidate visitation locations;
program instructions to identify, by the computer, an optimal total path using a computed optimal total driving distance associated with the shortest path between the candidate visitation locations; and
program instructions to calculate, by the computer, a driving cost associated with the optimal total path.

18. The computer program product of claim 15, further comprising:
program instructions to update, by the computer, the calculated duration and associated costs using weather prediction data including values of precipitation, wind and temperature.

19. The computer program product of claim 15, further comprising:
program instructions to update, by the computer, the calculated duration and associated costs using business-related constraints including vehicle limitations and staff limitations at specific areas, task urgencies, and other business-specific constraints.

20. The computer program product of claim 15, further comprising:
program instructions to generate, by the computer, a daily schedule for each operator for all available task locations in the predetermined area indicating available tasks, task values and task durations to be completed within a predetermined time period.
